(19) United States
(12) Patent Application Publication
(10) Pub. No.: US 2026/0196087 A1
(43) Pub. Date: Jul. 9, 2026

(54) METHOD AND APPARATUS FOR CALIBRATING AN ADAS ELECTRONIC DEVICE OF AN ADVANCED DRIVING ASSISTANCE SYSTEM OF A VEHICLE

(71) Applicant: TEXA S.P.A., MONASTIER DI TREVISO (TV) (IT)

(72) Inventor: Bruno Vianello, MONASTIER DI TREVISO (TV) (IT)

(73) Assignee: TEXA S.P.A., MONASTIER DI TREVISO (TV) (IT)

(21) Appl. No.: 19/130,721

(22) PCT Filed: Nov. 16, 2023
(86) PCT No.: PCT/IB2023/061601

§ 371 Date: May 16, 2025

(30) Foreign Application Priority Data
Nov. 18, 2022 (IT) 102022000023826

(51) Int. Cl. G07C 7/00; G01B 11/27; G06T 7/70

(52) U.S. Cl. CPC G07C 7/00; G01B 11/272; G06T 7/70

(57) ABSTRACT

A method for calibrating a driving assistance system of a vehicle using a calibration apparatus. The calibration apparatus comprises a calibration panel that is mechanically coupled to a supporting frame to translate and/or rotate. The method involves arranging at least one positioning target on the calibration panel, capturing one target image of the positioning target, and processing the target image to determine the axial and/or angular position of the calibration panel.

### CROSS-REFERENCE TO RELATED APPLICATIONS

This Patent application claims priority from Italian Patent Application No. 102022000023826 filed on Nov. 18, 2022, the entire disclosure of which is incorporated herein by reference.

### TECHNICAL FIELD

This invention relates to a calibration method and apparatus for calibrating an advanced driving assistance system of a vehicle.

This invention also concerns a method for determining the position of a calibration panel in an apparatus for calibrating an electronic device of an advanced driving assistance system of a vehicle.

### PRIOR ART

As is known, in recent years the use of electronic systems that implement functions of advanced driving assistance dedicated to the vehicle driver have become especially widespread in the motor vehicle sector (cars, motorbikes, buses, trucks, etc.).

The above-mentioned electronic systems are commonly identified as ADAS (acronym for Advanced Driver Assistance Systems) vehicle systems and comprise various ADAS electronic devices, such as, for example, cameras, radar sensors, infrared sensors, assembled on the vehicle.

The great complexity of ADAS vehicle systems gave rise to the need, especially among operators in the vehicle repair sector, for example, multi-brand and bodywork mechanical garage operators, to have tools to calibrate the cameras, radar sensors, and infrared sensors of ADAS vehicle systems so as to correctly restore their operation, during vehicle repair/maintenance work.

To this end, calibration apparatuses for calibrating the advanced driving assistance systems (ADAS) were devised that are designed to automatically perform the ADAS electronic device calibration procedures mentioned above.

The calibration apparatuses that implement the calibration procedure of some ADAS electronic devices are commonly provided with calibration panels.

To be able to perform the calibration procedure of some ADAS electronic devices, for example the radar sensor or the infrared sensor, you need to correctly position the corresponding calibration panel in relation to the ADAS electronic device of the vehicle to be calibrated so as to meet the calibration specifications established by the vehicle manufacturer.

To calibrate, for example, the radar sensor, the above-mentioned positioning is performed: by aligning, using a LASER pointer device, a predetermined reference point of the radar calibration panel with a predetermined reference point of the radar sensor, and rotating the radar calibration panel around a horizontal axis according to a predetermined calibration angle in relation to a vertical plane.

In some calibration apparatuses, the operator performs the above-mentioned positioning of the radar calibration panel at least partially manually.

A technical problem of the above-mentioned ADAS calibration apparatuses concerns the introduction of calibration panel position errors during manual positioning.

An angular or axial shift of the calibration panel in relation to the calibration position established by the manufacturer can seriously affect the outcome of the ADAS electronic device calibration by the ADAS calibration apparatus and can cause the incorrect operation of some ADAS vehicle functions, thus exposing the driver of the car to a hazard.

### DESCRIPTION OF THE INVENTION

The purpose of this invention is, thus, to provide a calibration method and apparatus for calibrating an ADAS electronic device of an advanced driving assistance system of a vehicle that overcomes the above-mentioned technical problems.

In accordance with this purpose, according to this invention a calibration apparatus for calibrating an ADAS electronic device of an advanced driving assistance system of a vehicle, according to what is indicated in the attached claims, is provided.

In accordance with this purpose, according to this invention, a method for calibrating an ADAS electronic device of an advanced driving assistance system of a vehicle using a calibration apparatus, according to what is indicated in the attached claims, is provided.

In accordance with this purpose, according to this invention, a method for determining the position of a calibration panel using a calibration apparatus of an advanced driving assistance system of a vehicle, according to what is indicated in the attached claims, is provided.

The claims describe preferred embodiments of this invention forming an integral part of this description.

### BRIEF DESCRIPTION OF THE DRAWINGS

This invention will now be described with reference to the attached drawings that illustrate a non-limiting embodiment thereof, in which:

FIG. 1 is a perspective view of a calibration apparatus of an advanced driving assistance system of a vehicle in a service area produced according to the precepts of this invention,

FIG. 2 is a front, elevated view of the calibration apparatus shown in FIG. 1,

FIG. 3 is a perspective view from below, on an enlarged scale, of a part of the calibration apparatus shown in FIG. 1,

FIG. 4 is a side perspective view, on an enlarged scale, of a part of the calibration apparatus shown in FIG. 1.

FIG. 5 is a view from below, partially in cross-section, with parts removed for clarity, of the calibration apparatus shown FIG. 1,

FIGS. 6 and 7 are as many side views of the calibration apparatus wherein the calibration panel is arranged according to two different angles,

FIGS. 8 and 9 are as many side views of a part, on an enlarged scale, of the calibration apparatus shown in FIGS. 3 and 4, wherein the calibration panel is arranged according to two different angles,

FIGS. 10 and 11 are as many rear perspective views of a calibration panel of the calibration apparatus shown in FIG. 1,

FIGS. 12 and 13 are a front, elevated view and, respectively, side view of the calibration apparatus comprising a calibration panel structured to calibrate an ADAS camera,

FIGS. 14 and 15 are a front, elevated view and, respectively, side view of the calibration apparatus comprising a calibration panel structured to calibrate an infrared sensor.

### PREFERRED EMBODIMENTS OF THE INVENTION

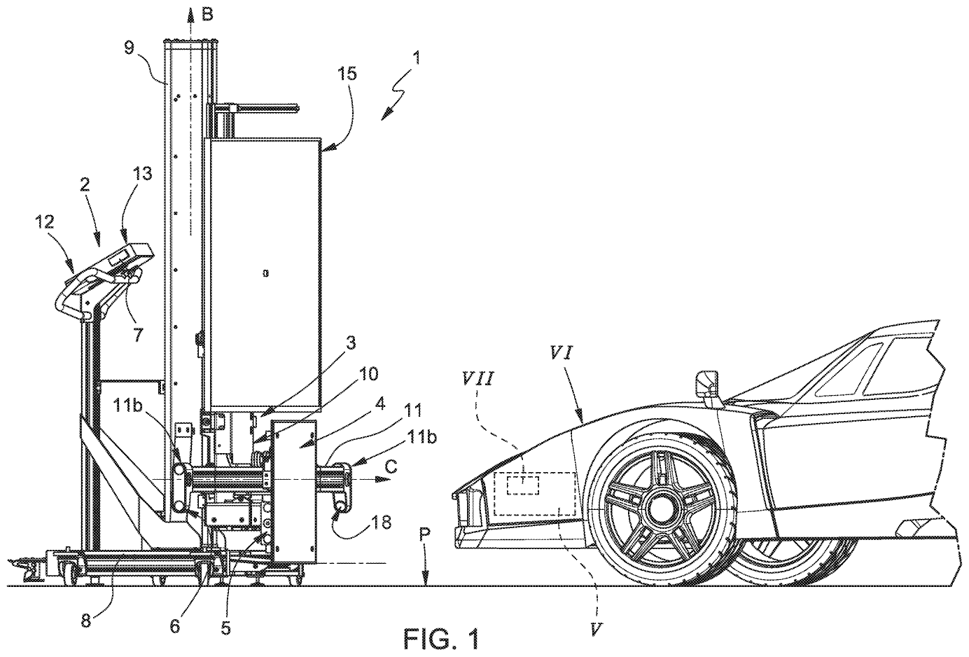

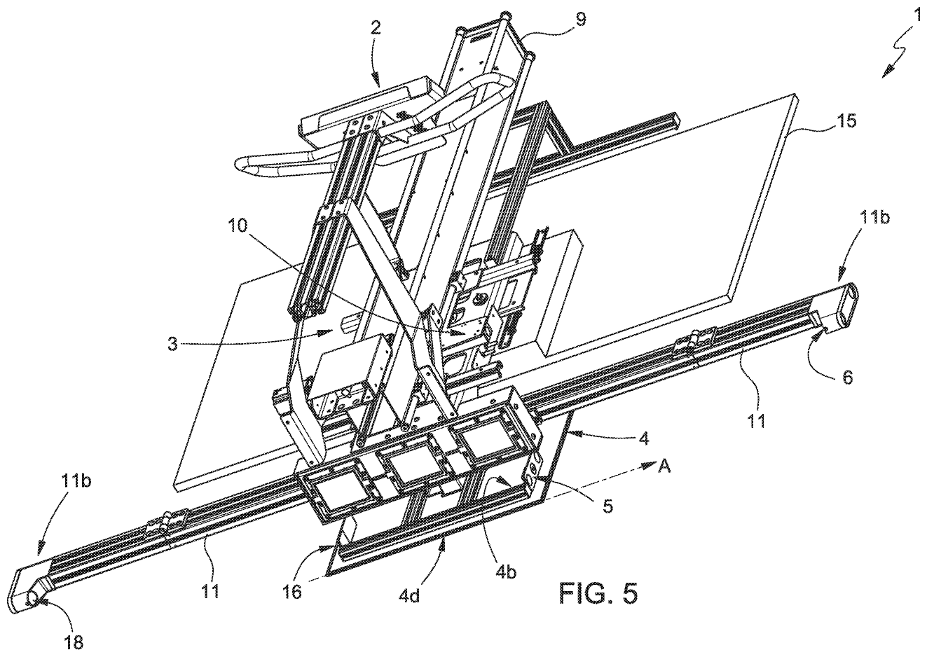

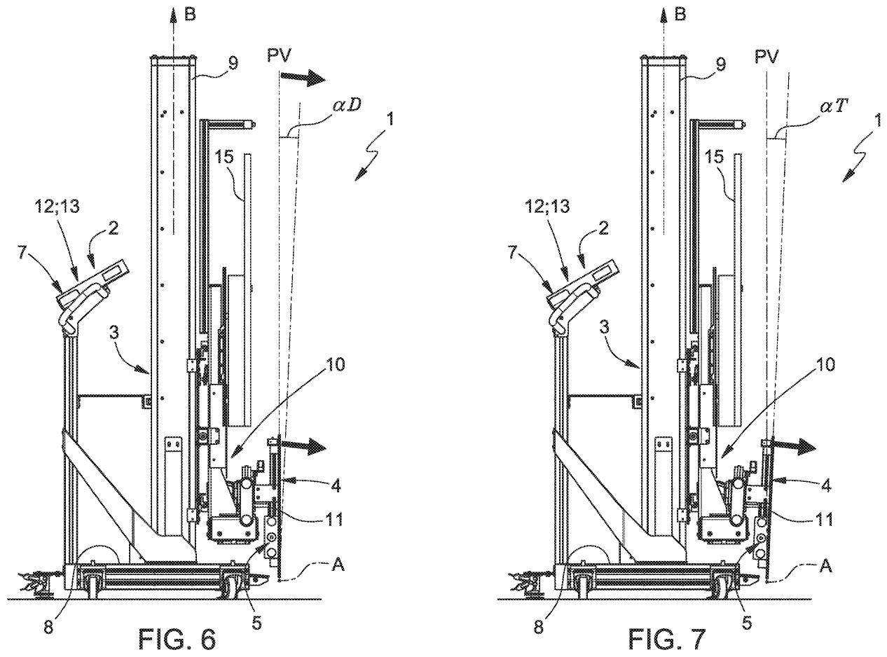

With reference to FIGS. 1-15, reference number 1 denotes, as a whole, a calibration apparatus that is configured so as to calibrate at least one ADAS electronic device of an advanced driving assistance system V of a vehicle VI. The vehicle VI corresponds to a motor vehicle, such as a car (automobile), a motor vehicle, or the like.

In the example illustrated in FIG. 1, the calibration apparatus 1 is arranged in a service station opposite and facing a vehicle VI (a car) arranged, in turn, to rest on a common (horizontal) plane P.

The advanced driving assistance systems V indicated below, for brevity, as an ADAS vehicle system V is known and, not being the subject of this invention, will not be further described, except to specify that it comprises one or more ADAS electronic devices VII. An ADAS electronic device VII may comprise, as preferred: an ADAS radar sensor, an ADAS optical sensor, one or more ADAS cameras, one or more LIDAR sensors, an ultrasound sensor, and an infrared sensor (IR).

The calibration apparatus 1 is provided with an electronic control system 2 that is configured so as to perform one or more calibration functions of the ADAS electronic devices VII of the ADAS system V. According to this invention, the electronic control system 2 is configured to perform at least one calibration function for calibrating the ADAS electronic device VII of the ADAS system V of the vehicle VI.

The calibration apparatus 1 comprises a supporting frame 3 and at least one calibration panel indicated in FIGS. 1-11 with the reference number “4” that is mechanically coupled to the supporting frame 3 so as to translate along an axis and/or rotate around an axis.

As shown in FIGS. 1-11, according to this invention, the calibration apparatus 1 comprises at least one positioning target 5 that is connected to the calibration panel 4 and/or to its support structure. In the example illustrated, the positioning target 5 is arranged on the calibration panel 4. In the example illustrated, the positioning target 5 is permanently fixed to the calibration panel 4.

The calibration apparatus 1 comprises, in addition, at least one electronic image acquisition device 6 that is mechanically coupled to the supporting frame 3 and is configured to capture at least one target image of the positioning target 5 of the calibration panel 4, and an electronic processing device 7 that is configured so as to process the captured target image of the positioning target 5 to determine the axial and/or angular position of the calibration panel 4.

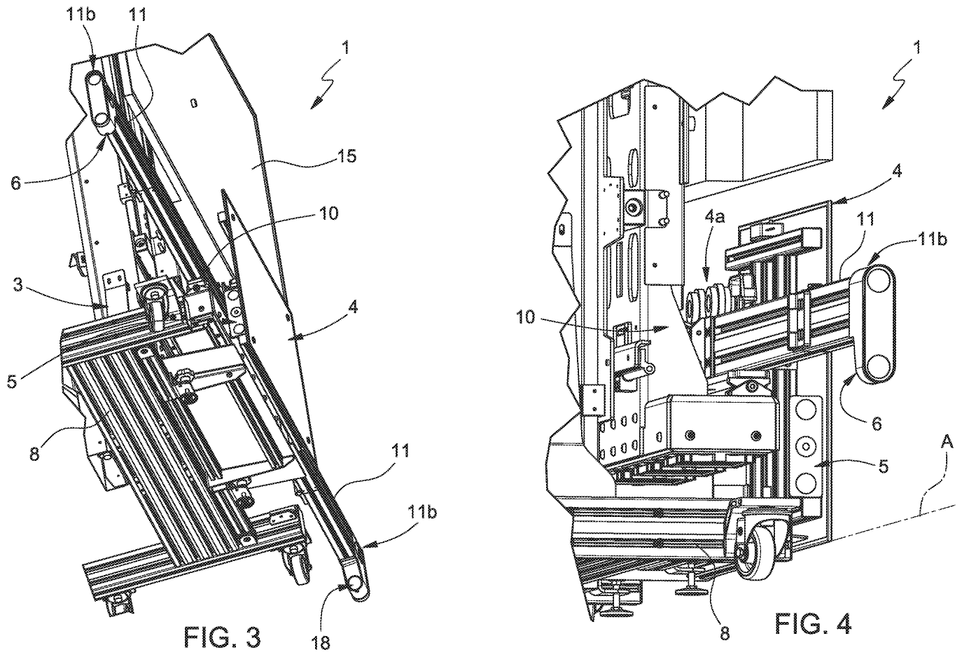

According to a preferred embodiment shown in FIGS. 3, 4 and 6-9, the calibration panel 4 is mechanically coupled to the frame 3 to rotate around a horizontal reference axis A so as to be tilted in relation to a vertical reference plane PV parallel to the horizontal reference axis A (FIGS. 3 and 4).

In the example illustrated, the electronic processing device 7 is configured to process the captured target image of the positioning target 5 to determine a first value indicating the tilt (rotation) of the calibration panel 4 in relation to the vertical reference plane PV based on the target image.

The electronic processing device 7 may comprise a computing circuit or module (microprocessor or computer or the like) programmed to implement a processing and analysis algorithm for digital images (electronic images) that, according to this invention, are the target images. For example, the algorithm may implement contactless image measuring procedures or techniques. For example, an image may measuring technique be based on Digital Image Correlation, two-dimensional, or three-dimensional analysis. The measuring technique may implement multiple functions such as, for example, target image filtering functions, target image pixel interpolation functions, or target image pose estimation functions. It is understood that the digital image processing and analysis algorithm is not limited to an image measuring technique based on the analysis of the correlation of digital images, but may involve other, similar digital image processing techniques.

The electronic control system 2 is configured so as to perform a calibration function or procedure of the ADAS electronic device VII using the calibration panel 4. The calibration function or procedure of the ADAS electronic device VII using the calibration panel 4 is implemented via a known ADAS calibration algorithm that depends on the type of ADAS electronic device VII to calibrate and, not being the subject of this invention, is not described further.

According to a possible embodiment of this invention shown in FIGS. 1-15, the supporting frame 3 may comprise a resting platform or base unit 8. The base unit 8 may, preferably, be mobile on the plane P (in one or more directions), for example via multiple wheels pivoting around corresponding vertical axes.

According to a possible embodiment of this invention shown in FIGS. 1-4, the supporting frame 3 may preferably, but not necessarily, comprise a support column 9. In the example illustrated, the column 9 extends along a vertical axis B. The column 9 may, preferably, but not necessarily, be mechanically coupled to the underlying base unit 8 via a mechanical assembly (not illustrated), so that it can rotate around the vertical axis B in relation to the base unit 8.

According to a possible embodiment of this invention shown in FIGS. 1-15, the supporting frame 3 may preferably comprise a supporting structure 10. The supporting structure 10 may, preferably, be coupled to the column 9 and/or to the base unit 8. In the embodiment illustrated in FIGS. 1-7, the supporting structure 10 is mechanically mounted, for example, on the column 9 so as to vertically move along the vertical axis B, from and towards the base unit 8. The rotation of the column 9 around the vertical axis B also determines the rotation of the supporting structure 10 around the axis B.

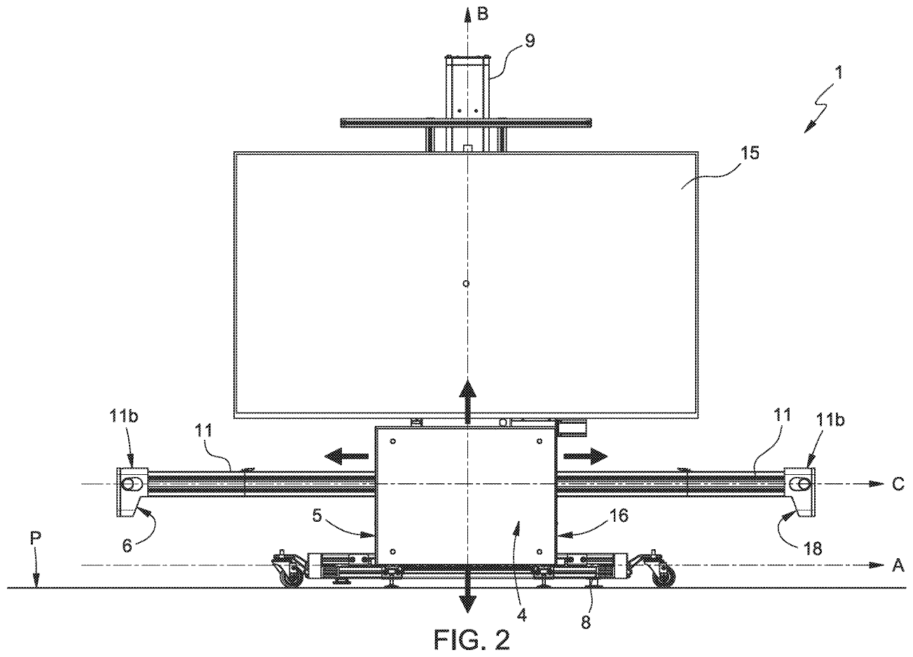

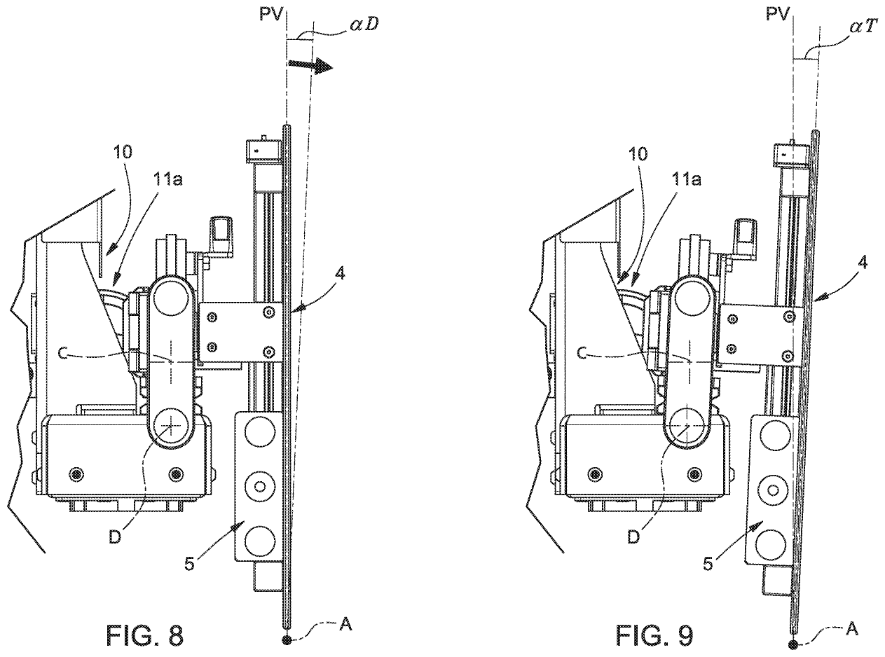

According to a possible embodiment of this invention shown in the attached figures, the supporting frame 3 may also, preferably, comprise a support bar 11. In the example illustrated, the support bar 11 may be coupled to the supporting structure 10. As shown in the attached figures, the support bar 11 extends along an axis C. In the example illustrated, the axis C is basically parallel to the horizontal reference axis A. The support bar 11 may be centrally coupled to the supporting structure 10 via mechanical coupling components 11a (FIGS. 8 and 9). As shown in FIGS. 1 and 2, the support bar 11 may extend so that it overhangs the supporting structure 10, so as to have its opposite ends 11b symmetrical in relation to the axis B. The ends 11b may be turned towards the two vertical sides of the calibration apparatus 1 that are arranged in symmetrical positions in relation to the vertical axis B.

The support bar 11 may comprise, for example, a rod or crossbar. The support bar 11 may consist of a straight section made of rigid material, preferably metal, for example aluminium or the like, having a preferably quadrangular cross-section, and is sized so as to laterally extend to the calibration apparatus 1 on both opposite sides.

According to one possible embodiment of this invention shown in FIGS. 1, 10, and 11, the calibration panel 4 may comprise a quadrangular plate-shaped body 4d having a front face turned towards the vehicle VI.

With reference to the preferred embodiment shown in FIGS. 1-11, the front face of the plate-shaped body 4d may be structured, for example, to reflect the radar signals generated by an ADAS electronic device VII corresponding to a radar sensor during its calibration. The calibration panel 4 may be a Radar calibration panel. The calibration panel 4 may also comprise a support frame of the plate-shaped body 4d comprising, for example, a quadrangular frame and frame connecting elements.

In the example illustrated in FIGS. 1-9, the calibration panel 4 is coupled to the support bar 11. In the example illustrated in FIGS. 1-9, the calibration panel 4 is coupled to the support bar 11 so as to rotate, or be rotated, around the horizontal reference axis A so as to be tilted in relation to the vertical reference plane PV.

According to one possible embodiment of this invention shown in FIGS. 1-9, the calibration panel 4 is coupled to the support bar 11 so that its rotation (angular movement) around the horizontal reference axis A is partial, i.e., within an angular range measured in relation to the vertical reference plane PV (arranged at 0° on the vertical) ranging between approximately −30° and +30°, preferably −2° and 2°. In other words, the calibration panel 4 is preferably coupled to the support bar 11 so as not to complete a full rotation (360°) around the horizontal reference axis A, but, on the contrary, only completes a partial rotation to be slightly tilted downwards (for example +2°) or upwards (for example −2°) in relation to the vertical reference plane PV by an angle that can vary within a tilt range of approximately −30° and approximately +30°.

It is understood that, according to the embodiment shown in the attached figures, the calibration panel 4 is designed to be rotated around the axis B by the support bar 11, when the support column 9 rotates around the axis B.

According to one possible embodiment shown in FIGS. 8-9, the mechanical coupling components 11a are structured so as to rotate the support bar 11 in relation to the supporting structure 10, around an axis D parallel to the horizontal reference axis A. According to this embodiment, the partial rotation of the support bar 11 around the axis D, causes a relative, partial rotation of the calibration panel 4 around the horizontal reference axis A.

According to one possible embodiment illustrated in FIGS. 1, 8-9, the mechanical coupling components 11a may, preferably, be electromechanical devices. The electromechanical devices may comprise, for example, an electric motor or an electric actuator (not illustrated) designed to rotate the support bar 11 around the axis D based on an electric command.

It is understood that the calibration apparatus 1 according to this invention is not limited to the embodiment illustrated in FIGS. 1-9, wherein the calibration panel 4 is coupled to the support bar 11 and is, thus, rotated (indirectly) around the axis A and/or B, by means of a corresponding rotation of the support bar 11. Other solutions and/or other coupling mechanisms may be included for coupling the calibration panel 4 to the supporting frame 3 that enable the calibration panel 4 to perform the same rotations around the horizontal reference axis A so as to be tilted and/or rotations around the vertical axis B.

For example, according to a different embodiment (not illustrated) there is no support bar 11 and the mechanical coupling components 11a couple the calibration panel 4 to the supporting structure 10. In this case, the electronic image acquisition devices 6 may be coupled to the supporting frame 3, for example using support elements laterally fixed to the supporting frame 3 and/or to the supporting structure 10.

According to an additional, different embodiment (not illustrated), the support bar 11 is connected to the supporting structure 10 in an angularly fixed way and the mechanical coupling components 11a connect the calibration panel 4 to the support bar 11 so as to rotate the calibration panel 4 around the horizontal reference axis A in relation to the support bar 11.

According to a preferred embodiment of this invention shown in FIGS. 1-9, the calibration apparatus may be structured to ensure that the calibration panel 4 may, conveniently, be moved (translated) along the axis C (or the axis A) as well.

In the example illustrated in the attached figures, the calibration panel 4 is mounted on the support bar 11 and is coupled to the same so as to translate along the support bar 11, i.e., along the axis C.

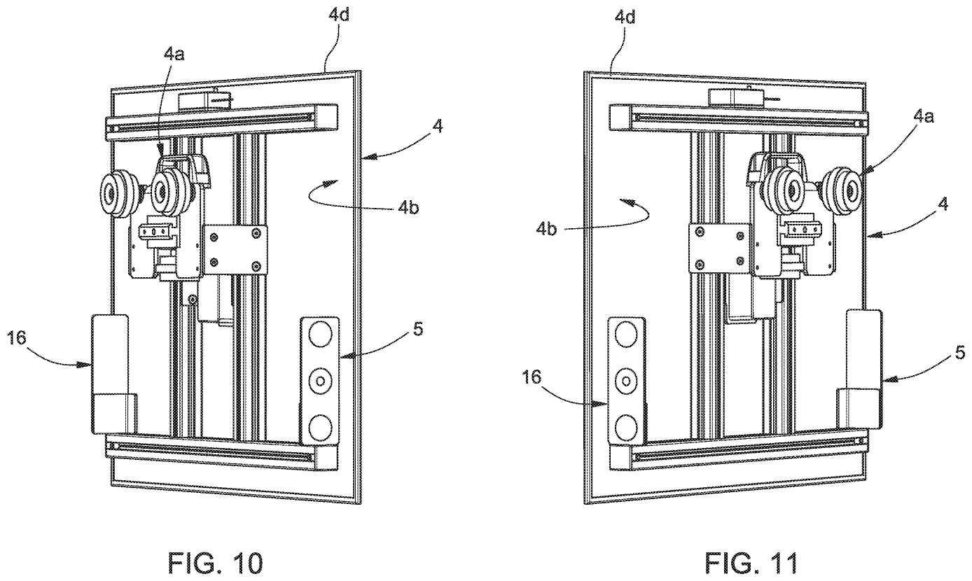

According to the embodiment shown in FIGS. 1-11, the calibration panel 4 is axially coupled so as to slide on the support bar 11 using a mechanical component 4a so as to translate along the support bar 11, i.e., along the axis C. In the example illustrated in FIGS. 10 and 11, the mechanical component 4a comprises, for example, at least one carriage or sliding block that is provided with rollers and/or wheels and is mounted on the rear face 4b of the calibration panel 4. The rollers or wheels of the carriage or sliding block may be mounted idle so as to enable the manual movement of the calibration panel 4 on the support bar 11. It is understood that, alternatively or in addition, the rollers or wheels of the sliding block may be motorised, i.e., rotated, in a controlled way, b corresponding electric actuators and/or electric motors (not illustrated) based on an electric drive command provided, for example, by the electronic processing device 7.

According to a preferred embodiment shown in FIGS. 1-9, the electronic image acquisition device 6 is conveniently arranged on one end 11b of the support bar 11. Conveniently, the image acquisition device 6 may comprise a video or photographic camera that is permanently coupled approximately to the end 11b of the support bar 11 and is oriented (turned) towards the calibration panel 4 so as to frame and capture the target image of the comprise positioning target 5.

The electronic image acquisition device 6 may comprise a digital video or photographic camera, or any similar device operating to acquire digital images in the range of the whole electromagnetic spectrum or, alternatively or additionally, selectively acquire digital images within a predetermined range of the electromagnetic spectrum (for example, the infrared spectrum).

According to a preferred embodiment of this invention, the electronic processing device 7 may comprise a memory module (not illustrated) and is also configured so that: it stores in the memory module a second value indicating a predetermined tilt (rotation) of the calibration panel 4 in relation to the vertical reference plane PV. The second value may correspond to an angular position, indicated below with angle αT, that is set by the vehicle manufacturer for the calibration of the sensor device VII (for example, the radar sensor). In other words, the second value may indicate a predetermined angle αT between the rest plane of the titled calibration panel 4 and the vertical reference plane PV in the correct execution of the calibration procedure (for example, a calibration of the radar sensor VII) predetermined by the vehicle manufacturer.

The electronic processing device 7 is also configured so that: it captures multiple target images of the positioning target 5 during the rotation of the calibration panel 4 around the horizontal reference axis A, it measures or determines for each target image a corresponding first value, indicated below with αD, indicating the tilt (for example the rotation angle) of the calibration panel 4 in a certain instant, and verifies if the first determined or measured value αD and the second predetermined value αT indicating the angle αT, satisfy, between them, a predetermined tilt (rotation) of the calibration panel 4. For example, the predetermined tilt (rotation) of the calibration panel 4 could be verified when the first value αD is equal to the second predetermined value αT.

The electronic processing device 7 is also configured so that it performs and/or prevents the performance of the ADAS calibration function/procedure based on the outcome of the above-mentioned check of the first value αD and second predetermined value αT. For example, the electronic processing device 7 may interrupt the performance of the ADAS calibration function/procedure of an ADAS electronic device when it determines that the first value αD is not equal to the second predetermined value αT. The calibration apparatus 1 may start the calibration of the radar sensor VII in response to determining the predetermined tilt (rotation) by the electronic processing device 7, for example when the first value αD is equal to the second predetermined value αT.

According to a preferred embodiment, the calibration apparatus 1 may comprise a user interface device 12 through which an operator can receive information for setting (determining) the position of the calibration panel 4. The user interface device 12 may be connected, with wires or without, with the electronic processing device 7 to receive, provide data/information.

In the example illustrated in FIGS. 1, 6, and 7, the user interface device 12 comprises a display or monitor (preferably touch-screen or the like). In the example illustrated, the display or monitor is arranged in a control panel 13 mechanically coupled to the supporting frame 3 and is designed to enable the operator to give commands to the calibration apparatus 1. It is understood that, in addition and/or alternatively, the display or monitor of the user interface device 12 may be present in any of the operator's portable communication devices (smartphone or tablet or the like). It is understood that, in addition or alternatively, the display of the user interface device 12 may consist of a monitor 15 that is mechanically coupled to the supporting frame 3 above the calibration panel 4, communicates with the electronic processing device 7 so as to exchange data, and is designed to be used for the calibration of ADAS cameras of the ADAS system V of the vehicle VI.

According to a preferred embodiment wherein the calibration panel 4 can be manually rotated, the electronic processing device 7 is configured so that: it processes the target images of the positioning target 5 captured during the rotation of the calibration panel 4 around the horizontal reference axis A and determines, based on the target images captured, the first values αD indicating the tilt (rotation) of the calibration panel 4 during rotation. The electronic processing device 7 is also configured so that: it provides the operator assistance information that tells them how to rotate (for example the angle and/or towards) the calibration panel 4 to attain the predetermined tilt (rotation) in real time, i.e., during the rotation of the calibration panel 4, via the user interface device 12, based on the shift between the first determined values αD and the second predetermined value αT. If the display of the user interface device 12 consists of the monitor 15 controlled by the electronic processing device 7, the operator is conveniently placed opposite the same and, observing it, conveniently receives all the assistance information displayed by the monitor 15 necessary to assist operator in positioning the calibration panel 4 in the predetermined tilt (rotation). For example, the electronic processing device 7 may communicate (display) in real time a numeric value corresponding to the angular shift determined between first determined values αd and the second predetermined value αT; the operator thus rotates the calibration panel 4 to reduce the angular shift displayed to zero. It is understood that, in addition or alternatively, the user interface device 12 may comprise a haptics interface able to communicate information that it can tactilely perceive to the operator. For example, the user interface device 12 may comprise a haptics device installed directly on the calibration panel 4. For example, the haptics device may help the operator to reduce the angular shift to zero by proportionally modulating vibrations based on the shift. It is understood that, in addition or alternatively, the user interface device 12 may comprise an acoustic (sound) interface able to communicate vocal or sound messages to the operator. For example, the user interface device 12 may help the operator to reduce the angular shift to by generating predetermined vocal messages (indicating the rotation to perform) and/or acoustic signals (sound impulses) modulated based on the shift.

According to a preferred embodiment, the electronic processing device 7 is configured so as to detect an incorrect tilt (rotation) of the calibration panel 4 when the first value αD (whether determined or measured) is different to the second predetermined value T. The electronic processing device 7 is configured to generate an angle error signal indicating the angular shift between the first value αD and the second predetermined value αT.

According to the embodiment shown in FIGS. 1-11, wherein the rotation of the calibration panel 4 is performed (indirectly) by the rotation of the support bar 11 by means of motorised mechanical coupling components 11a, the electronic processing device 7 may drive the latter so as to automatically rotate the support bar 11 around the axis D based on said shift, to reduce the angle error signal to zero.

According to an embodiment shown in FIGS. 1-9, the electronic processing device 7 may communicate the angle error signal via the user interface device 12 to indicate the presence of an incorrect tilt (rotation) to the operator.

According to a preferred embodiment wherein the mechanical coupling components 11a are provided with electric motors and/or electric actuators that automatically rotate the calibration panel 4 around the horizontal reference axis A to tilt it in relation to the vertical reference plane PV, the electronic processing device 7 may be configured so as to control the electric motors and/or electric actuators to automatically rotate the calibration panel 4 around the horizontal reference axis A based on the first values αD determined during rotation and said second predetermined value αT. In other words, the electronic processing device 7 automatically drives (in reverse) the electric motors and/or electric actuators based on the first values αD during rotation and said second predetermined value αT to automatically control the rotation of the calibration panel 4 so as to cause it to attain the predetermined tilt (rotation) wherein the angle error is zero.

According to a preferred embodiment wherein the calibration panel 4 translates along an axis parallel (for example along the support bar 11) to the horizontal reference axis A, the electronic processing device 7 is configured so that it captures, using the image acquisition device 6, the target images during the axial movement of the calibration panel 4, processes the captured target images of the positioning target 5, and determines, for each target image, a third value indicating the axial position of the calibration panel 4 along the axis (compared to a predetermined reference system) based on the target image.

According to one convenient embodiment, the calibration apparatus 1 comprises, in addition to the first positioning target 5, a second positioning target 16 as well that is connected with the calibration panel 4 in a symmetrical position and opposite the positioning target 5 in relation to the vertical midplane axis of the calibration panel 4. According to this embodiment, the calibration apparatus 1 comprises an electronic image acquisition device 18 that is coupled to the supporting frame 3 in a position opposite the other electronic image acquisition device 6.

The electronic image acquisition device 18 is configured and oriented (turned) so that it captures at least one target image of the corresponding positioning target 16 of the calibration panel 4. In other words, the calibration apparatus 1 comprises a pair of positioning targets 5 and 16 permanently arranged on the calibration panel 4 and a pair of electronic image acquisition devices 6 and 18 that are arranged symmetrically to each other in relation to the vertical axis B and are designed to acquire the target images of the corresponding positioning targets 5 and 16.

The Applicant has found that the combined use of the pair of positioning targets 5 and 16 and pair of electronic image acquisition devices 6 and 18 and the processing of the target images by the electronic processing device 7 makes it possible to improve the precision both in determining/measuring the angular shift of the calibration panel 4, i.e. the tilt (rotation) around the horizontal reference axis A, and in determining/measuring the axial shift of the calibration panel 4 along the axis C (or axis A).

According to the convenient embodiment shown in FIGS. 1-11, the positioning targets 5 and 16 are fixed to two vertical, lateral sides of the calibration panel 4 that are symmetrical in relation to the vertical midplane axis of the calibration panel 4, and the electronic image acquisition devices 6 and 18 are permanently fixed to the opposite ends 11b of the support bar 11 so that they are each turned towards the corresponding positioning target 5 and 16 so as to capture its corresponding target image.

According to this convenient embodiment, the electronic processing device 7 is configured in order to determine the first values αD indicating the tilt (rotation) of the calibration panel 4 with respect to the vertical reference plane PV on the basis of the captured target-images in relation to the couple of positioning targets 5 and 16.

According to this convenient embodiment, the first values αD determined by the electronic processing device 7 are processed by the same similarly to what was described above to determine the tilt (rotation) of the calibration panel 4 in relation to the vertical plane PV with the aim of performing the same functions described above concerning the embodiment that involves processing the target image of a positioning target 5.

Conveniently, the positioning target/s 5 and 16 are two-dimensional and comprise plate-shaped bodies. The plate-shaped bodies are flat and may be conveniently, permanently fixed to the rear face 4b of the calibration panel 4. The plate-shaped bodies of the positioning targets 5 and 16 are fixed to the two opposite, vertical sides of said calibration panel 4 and have, on their opposite faces (turned towards the corresponding electronic image acquisition devices 6, 18), two-dimensional images (quadrangular, for example rectangular) that represent predetermined patterns. In the example illustrated, in FIGS. 1-11, the pattern has a shape containing graphic elements. In the embodiment shown in FIGS. 1-11, the graphic elements may be conveniently depicted on a flat surface having a neutral-coloured background, preferably a black or white background.

As far as concerns the vertical reference plane PV, it may be determined by the electronic processing device 7 in different ways. For example, the calibration apparatus 1 may be provided with inclinometers or gyroscopes (not illustrated) arranged, for example, on the supporting frame 3 and designed to provide data to the electronic processing device 7 that processes them to determine the vertical reference plane PV. In addition or alternatively, in the preferred embodiment shown in the attached figures that show the assembly of the electronic image acquisition devices 6 on the support bar 11 and the acquisition by the same of the target images of the positioning targets 5 and 16 mounted on the calibration panel 4 mounted so as to slide on the support bar 11, the calibration apparatus 1 may comprise fixed reference targets that may be framed and captured in the form of images by the electronic image acquisition devices 6, and processed by these to determine the vertical plane PV. For example, for this purpose, the calibration apparatus 1 could comprise a fixed reference target arranged on the base unit 8 so as to be framed by the electronic image acquisition devices 6, 18. The fixed reference target may be arranged on the base unit according to what is described in the Italian patent application no. 102021000015296 of the same Applicant, the contents of which (description and tables) are understood to be completely incorporated here for reference. The processing of the fixed reference target thus enables the electronic processing device 7 to determine information relating to the vertical reference plane PV.

Below, the operation method of the calibration apparatus 1 will be described, wherein it is imagined that the latter comprises: two positioning targets 5 and 16 mounted on the calibration panel 4 coupled, in turn, to the support bar 11 via the motorised mechanical coupling components 11a, and two electronic image acquisition devices 6, 18 arranged on the opposite ends 11b of the support bar 11. It is also imagined that the calibration panel 4 is designed to perform a radar calibration of an ADAS electronic device VII corresponding to a radar sensor.

In use, the calibration apparatus 1 is arranged opposite the vehicle VI approximately centrally in a position/plane orthogonal to the central longitudinal axis of the vehicle VI. The radar sensor may be calibrated when the calibration panel 4 satisfies an alignment with the radar sensor. To achieve the above-mentioned alignment, the method may involve controlling the tilt, i.e., the rotation, of the calibration panel 4 around the horizontal reference axis A. During rotation of the calibration panel 4 around the horizontal reference axis A, the method involves: capturing the target image of the positioning target 5 of the calibration panel 4, using the electronic image acquisition device 6; capturing the target image of the other positioning target 16 of the calibration panel 4, using the other electronic image acquisition device 18; determining the first value indicating the tilt (rotation) of the calibration panel 4 in relation to said vertical reference plane PV based on the target images of the positioning targets 5 and 16, using the electronic processing device 7; and controlling, moment by moment, the rotation of the calibration panel 4 based on the comparison between the first values αD and the second predetermined value αT.

To achieve the above-mentioned alignment, the method may also involve vertically moving the supporting structure 10 so as to vary the height of the support bar 11 so as to arrange the calibration panel 4 at a height (measured from the floor P) provided for by the alignment, based on a height relating to the ADAS electronic device VII. After achieving the predetermined height and tilt (rotation), to achieve the above-mentioned alignment, the method also involves translating the calibration panel 4 along the support bar 11 so that a predetermined point of the calibration panel 4 is aligned along a horizontal direction parallel to the longitudinal axis of the vehicle VI with a predetermined reference point of the radar sensor VII. This condition may be achieved using a collimated beam of light (LASER) generated by an optoelectronic device (for example, a laser device) pointer mounted in the predetermined point of the calibration panel 4. Thus, the operator may manually translate the calibration panel 4 until the of laser spot the beam intercepts the predetermined reference point of the radar sensor VII. During the translation of the radar target panel 4, the predetermined tilt of the calibration panel 4 may undergo variations due, for example, to mechanical play or mechanical deformations of the support bar 11. In this case, the calibration apparatus 1 may, thus, advantageously determine again the actual tilt of the calibration panel 4 by capturing and processing the target images of the targets 5 and 16 so as to adjust the tilt of the calibration panel 4 based on the shift detected between the first values αD and the second value αT.

It is understood that the calibration apparatus is able to determine, in a way similar to that described above, i.e., based on the processing of the image of the positioning target 5 the rotation of the calibration panel 4 around the vertical axis B as well.

The calibration apparatus described above has the advantage of increasing the precision in measuring the tilt of the calibration panel 4. Thanks to the processing of the target images of the positioning targets integral with the calibration panel 4, the apparatus is able to determine the precise tilt of the panel in every moment, thus eliminating errors. The automatic signalling of the tilt error makes it possible, if there is an accidental change to the tilt, to interrupt the calibration, significantly reducing the risk of performing mistaken calibrations, thus eliminating the risks for the driver of the vehicle deriving from the incorrect calibration of the ADAS radar sensor.

It is understood that this invention is not limited to a calibration apparatus provided with a calibration panel 4 consisting of a Radar calibration panel to calibrate ADAS system radars.

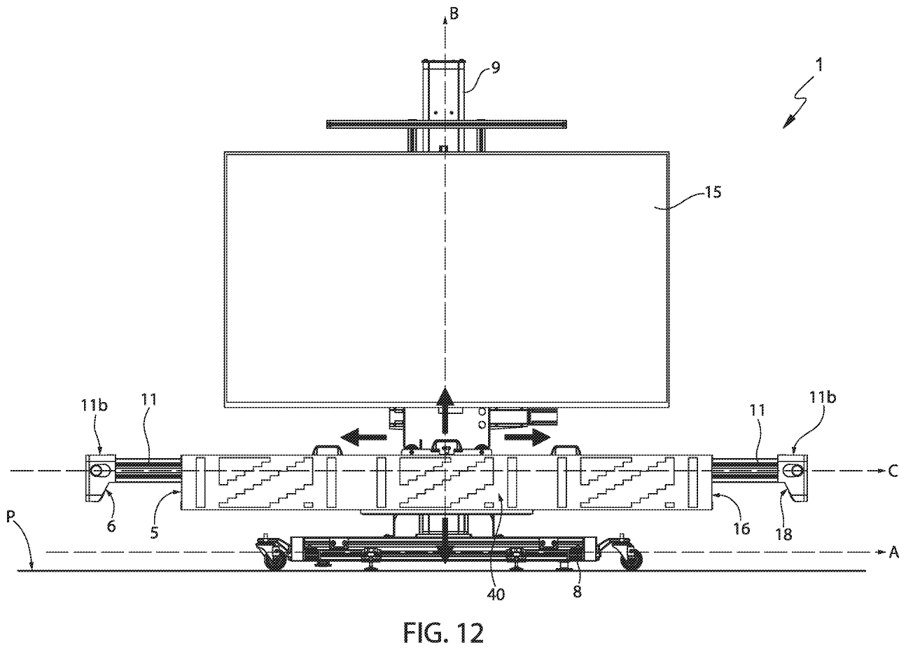

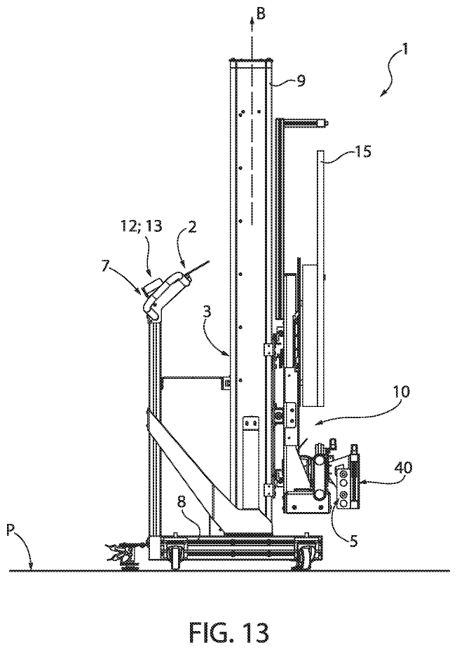

The embodiment shown in FIGS. 12 and 13 relates to a calibration apparatus 10, which is similar to the calibration apparatus 1 shown in FIGS. 1-11, and whose parts will be identified, where possible, with the same reference numbers that identify corresponding parts of the vehicle calibration equipment 1.

The calibration apparatus 1 shown in FIGS. 12 and 13 differs from the calibration equipment 1 shown in FIGS. 1-11 due to the fact that it comprises the calibration panel 40 structured so as to calibrate an ADAS electronic device VII corresponding to an ADAS camera of the vehicle VI. The calibration panel 40 may comprise a quadrangular plate-shaped body. According to the embodiment shown in FIGS. 12 and 13, on the front face of the plate-shaped body, there may be calibration targets of the ADAS camera. It is understood that the calibration panel 40 may comprise a monitor/display (flat, LCD, or OLED screen or the like) designed, in use, to display, on command, a digital image of the calibration targets of the ADAS camera.

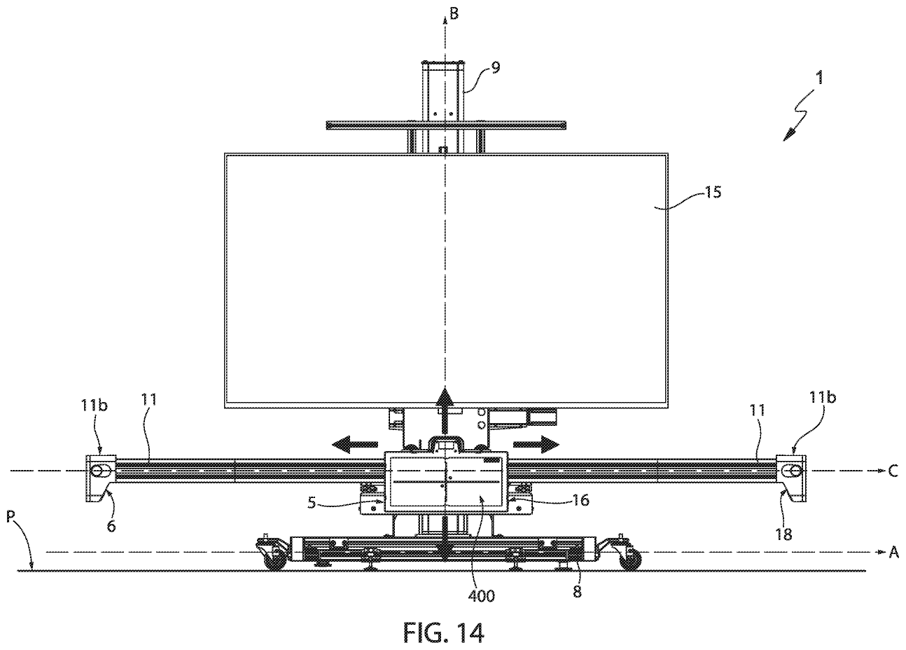

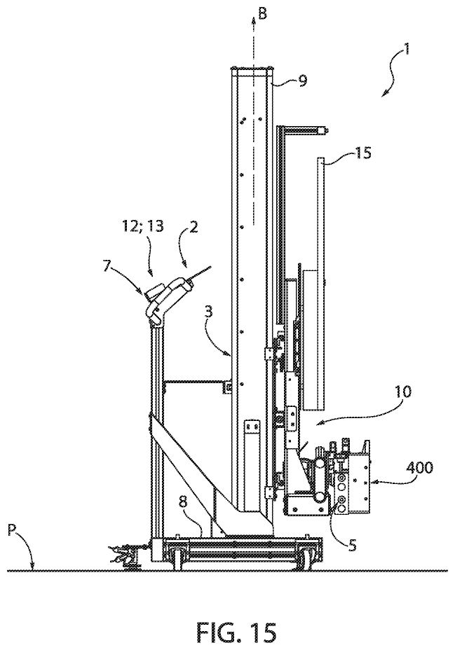

The calibration apparatus 1 shown in FIGS. 14 and 15 differs from the calibration equipment 1 shown in FIGS. 1-11 due to the fact that it comprises the calibration panel 400 structured to calibrate an ADAS electronic device VII corresponding to an infrared sensor of the vehicle VI. The calibration panel 400 may be structured to selectively vary the temperature on one or more predetermined areas/points of calibration of its front face.

It is understood that the calibration apparatus 1 may be provided with a series of calibration panels 4, and/or 40 and/or 400, each of which is designed to be coupled, stably but easily removably, with the supporting frame 3. In this way, it is conveniently possible to replace the calibration panels 4, 40, 400 based on the calibrations to perform.

1. A method for calibrating a driving assistance system of a vehicle mounted in a vehicle by means of a calibration apparatus,
wherein the calibration apparatus comprises:
a supporting frame,
a calibration panel which is mechanically coupled to said supporting frame in order to translate along an axis and/or rotate around an axis,
an electronic control system, which is configured in order to perform a calibration procedure of an ADAS electronic device of said driving assistance system of a vehicle by means of said calibration panel,
said method comprises the steps of:
associating at least one positioning target to said calibration panel,
arranging at least one electronic image acquisition device on said supporting frame,
capturing by said at least one electronic image acquisition device at least one target image of said positioning target of said calibration panel,
processing, by means of an electronic processing device, said at least one target image of said at least one positioning target in order to determine the axial position of said calibration panel along said axis and/or the angular position of said calibration panel-around said axis.

2. The method according to claim 1, wherein said calibration panel is mechanically coupled to said supporting frame in order to be able to rotate around a horizontal reference axis-so as to tilt with respect to a vertical reference plane parallel to said horizontal reference axis,
said method comprising the step of processing said at least one target image of said at least one positioning target by means of said electronic processing device to determine at least a first value indicative of the tilt of the calibration panel with respect to said vertical reference plane.

3. The method according to claim 2, comprising the step of:
memorizing by said electronic processing device a second value indicative of a pre-established tilt of the calibration panel with respect to said vertical reference plane in a correct condition execution of the calibration procedure of said ADAS electronic device (VII),
controlling by means of said electronic processing device whether the first determined value and the second predetermined value mutually satisfy a predetermined tilt condition of said calibration panel,
performing and/or inhibiting through said processing electronic device the execution of the calibration procedure of said ADAS electronic device based on the result of said control.

4. The method according to claim 3, further comprising the steps of
processing through said electronic processing device, the target images of said positioning target captured during the rotation of the calibration panel around said reference axis horizontal in order to determine on the basis of the captured target-images said first values indicative of respective tilts of the calibration panel during the said rotation,
providing the operator by a user interface device, assistance information indicative of the rotation that the operator should manually impart on the calibration panel around the horizontal reference axis to reach the pre-established tilt of the calibration panel, based on the first determined values and the second preset value.

5. The method according to claim 3, comprising the steps of:
processing said target image to determine the first value and
determining a condition of incorrect tilt of said calibration panel, when the first determined value is different from the second pre-established value.

6. The method according to claim 2, wherein said calibration apparatus comprises electric actuator/motorized means configured to rotate said calibration panel about said axis horizontal reference plane in order to tilt the calibration panel with respect to said vertical reference plane,
said method comprises the step of controlling said actuator/motorized electric means by means of said electronic processing device to automatically rotate said calibration panel around said horizontal reference axis on the basis of said first values determined during the rotation and of said second pre-established value.

7. The method according to claim 1, wherein
said calibration panel is further designed to translate along an axis parallel to said horizontal reference axis,
said method comprises the step of determining by means of said electronic processing device a third value indicative of an axial position of the calibration panel on the basis of said at least one target image of said at least a positioning target.

8. The method according to claim 1, wherein said calibration apparatus comprises:
a couple of positioning targets, which are stably fixed on two respective opposite vertical faces of said calibration panel,
a couple of electronic image acquisition devices, which are coupled to said supporting frame in mutually symmetrical positions with respect to a vertical axis of the calibration apparatus and are oriented and configured in order to capture the target images of the respective positioning targets of said calibration panel,
said method comprises the steps of determining first values indicative of the tilt of the calibration panel with respect to said vertical reference plane based on said target-images of the couple of said positioning targets.

9. The method according to claim 1, wherein said supporting frame comprises a support bar, which extends along a horizontal axis parallel to said horizontal axis of rotation, and supports said calibration panel and at least one electronic image acquisition device.

10. The method according to claim 9, wherein said support bar supports on the two opposite ends two electronic image acquisition devices oriented to capture the target images of said coupled of positioning targets of said calibration panel.

11. The method according to claim 1, wherein said calibration panel comprises by choice: a calibration panel designed to calibrate a radar sensor, a calibration panel designed to calibrate an ADAS camera, a calibration panel designed to calibrate an ADAS infrared device.

12. The method according to claim 1, wherein said calibration panel is mechanically coupled to said supporting frame in order to rotate around a vertical reference axis,
said method comprising the step of processing said at least one target image of said at least one positioning target by means of said electronic processing device to determine the angular position of the calibration panel around said vertical reference axis with respect to a predetermined reference system.

13. A calibration apparatus for calibrating a driving assistance system of a vehicle mounted in a vehicle,
the calibration apparatus comprises:
a supporting frame,
a calibration panel which is mechanically coupled to said supporting frame in order to translate along an axis and/or rotate around an axis,
an electronic control system, which is configured in order to perform a calibration procedure of an ADAS electronic device of said driving assistance system of a vehicle by means of said calibration panel,
said calibration apparatus comprises:
at least one positioning target associated with said calibration panel,
at least an electronic image acquisition device which is coupled to said supporting frame and is configured in order to capture at least one target image of said positioning target of said panel calibration,
a processing electronic device configured to process said at least one target image of said at least one positioning target to determine the axial position of the calibration panel along said axis and/or the angular position of the calibration panel around said axis.

14. The calibration apparatus according to claim 13, wherein said calibration panel is mechanically coupled to said supporting frame in order to rotate around a horizontal reference axis so as to tilt with respect to a vertical reference plane parallel to said horizontal reference axis,
said electronic processing device is also configured to process said at least one target image of said at least one positioning target to determine at least one first value indicative of the tilt of the panel calibration with respect to said vertical reference plane.

15. The calibration apparatus according to claim 14, wherein said processing electronic device is furthermore configured in order to:
memorize a second value indicative of a pre-established tilt of the calibration panel with respect to said vertical reference plane in a condition of correct execution of the calibration procedure of said ADAS electronic device,
control whether the first determined value and the second preset value satisfy each other a condition of preset tilt of the calibration panel,
perform and/or inhibit the calibration procedure of said ADAS electronic device on the basis of the result of said control.

16. The calibration apparatus according to claim 15, wherein the processing electronic device is further configured in order to:
process target-images of said positioning target captured during the rotation of the calibration panel around said horizontal reference axis to determine on the basis of the target-images captured said first values indicative of respective tilts of the calibration panel during the rotation,
providing the operator by a user interface device, assistance information indicative of the rotation that the operator should manually impart on the calibration panel around the horizontal reference axis to reach the preset tilt condition of the calibration panel, based on the first determined values and the second preset value.

17. The calibration apparatus according to claim 15, wherein the processing electronic device is further configured to:
processing said target image to determine the first value and
determining a condition of incorrect tilt of said calibration panel, when the first determined value is different from the second pre-established value.

18. The calibration apparatus according to claim 14, comprising electric actuator/motorized means designed to rotate said calibration panel around said horizontal reference axis in order to tilt the calibration panel with respect to said vertical reference plane,
said electronic processing device is configured in order to control said actuator/motorized electric means to automatically rotate said calibration panel around said horizontal reference axis on the basis of said first values determined during the rotation of the calibration panel, and of said second pre-established value.

19. The calibration apparatus according to claim 13, wherein
said calibration panel is further designed to translate along an axis parallel to said horizontal reference axis,
said electronic processing device is also configured in order to determine a third value indicative of an axial position of the calibration panel on the basis of said at least one target image of said at least one positioning target.

20. The calibration apparatus according to claim 13, comprising:
a couple of positioning targets, which are stably fixed on two respective opposite vertical faces of said calibration panel,
a couple of electronic image acquisition devices, which are coupled to said supporting frame in mutually symmetrical positions with respect to a vertical axis of the calibration apparatus and are oriented and configured in order to capture the target images of the respective positioning targets of said calibration panel,
said electronic processing device is configured in order to determine first values indicative of the tilt of the calibration panel with respect to said vertical reference plane on the basis of the said target-images of said couple of positioning targets.

21-25. (canceled)
